(19) United States
(12) Patent Application Publication
(10) Pub. No.: US 2024/0394497 A1
(43) Pub. Date: Nov. 28, 2024

(54) IMAGE FORMING SYSTEM, IMAGE FORMING METHOD AND NON-TRANSITORY COMPUTER READABLE RECORDING MEDIUM ENCODED WITH IMAGE FORMING PROGRAM

(71) Applicant: Konica Minolta, Inc., Tokyo (JP)

(72) Inventor: Kenji OKUBO, Tokyo (JP)

(73) Assignee: Konica Minolta, Inc., Tokyo (JP)

(21) Appl. No.: 18/672,759

(22) Filed: May 23, 2024

(30) Foreign Application Priority Data
May 26, 2023 (JP) 2023-087312

(51) Int. Cl. G06K 15/00; G03G 15/00; G03G 15/23

(52) U.S. Cl. CPC G06K 15/408; G03G 15/238; G03G 15/5012; G03G 15/5062

(57) ABSTRACT

An image forming system may comprise a first image forming apparatus arranged on a conveyance path of a recording medium, a second image forming apparatus arranged on the conveyance path at a position farther downstream than the first image forming apparatus in a conveyance direction of the recording medium, a first reading section arranged on the conveyance path between the first image forming apparatus and the second image forming apparatus, and reads the recording medium conveyed through the conveyance path, and a second reading section arranged on the conveyance path at a position farther downstream than the second image forming apparatus in the conveyance direction, and reads the recording medium conveyed through the conveyance path.

### CROSS-REFERENCE TO RELATED APPLICATIONS

This application claims priority to Japanese patent Application No. 2023-087312 filed on May 26, 2023, the entire contents of which is incorporated herein by reference.

### BACKGROUND OF THE INVENTION

### Technical Field

The present invention relates to an image forming system, an image forming method, and a computer-readable recording medium encoded with an image forming program. In particular, the present invention relates to an image forming system including a plurality of image forming apparatuses, an image forming method that is performed in the image forming system, and a computer-readable recording medium encoded with an image forming program that causes a computer to perform the image forming method.

### Description of Related Art

A technique for reading a sheet on which an image has been formed by an image forming apparatus and inspecting whether an image has been formed normally by the image forming apparatus is known (Patent Documents 1 to 3, for example). However, in an image forming system in which two image forming apparatuses are connected in series and the two image forming apparatuses respectively form images on the same sheet, it is difficult to detect which one of the two image forming apparatuses has caused an abnormality in image formation.

### SUMMARY OF THE INVENTION

According to one aspect of the present invention, an image forming system may comprise a first image forming apparatus arranged on a conveyance path of a recording medium, second image forming apparatus arranged on the conveyance path at a position farther downstream than the first image forming apparatus in a conveyance direction of the recording medium, a first reading section arranged on the conveyance path between the first image forming apparatus and the second image forming apparatus, and reads the recording medium conveyed through the conveyance path, and a second reading section arranged on the conveyance path at a position farther downstream than the second image forming apparatus in the conveyance direction, and reads the recording medium conveyed through the conveyance path.

According to another aspect of the present invention, an image forming method is performed in an image forming system, and the image forming system may comprise a first image forming apparatus arranged on a conveyance path of a recording medium, a second image forming apparatus arranged on the conveyance path at a position farther downstream than the first image forming apparatus in a conveyance direction of the recording medium, a first reading section arranged on the conveyance path between the first image forming apparatus and the second image forming apparatus, and reads the recording medium conveyed through the conveyance path, and a second reading section arranged on the conveyance path at a position farther downstream than the second image forming apparatus in the conveyance direction, and reads the recording medium conveyed through the conveyance path, and the image forming method may comprise a device control step of causing the first image forming apparatus to form an image on a first side of the recording medium and not to form an image on a second side opposite to the first side, and causing the second image forming apparatus to form an image on the second side of the recording medium and not to form an image on the first side, a first inspection step of detecting an abnormality of the first image forming apparatus based on image data output by the first reading section that reads the first side and the second side of the recording medium, and a second inspection step of detecting an abnormality of the second image forming apparatus based on image data output by the second reading section that reads the first side and the second side of the recording medium.

According to yet another aspect of the present invention, a non-transitory computer-readable recording medium is encoded with an image forming program executed by a computer that controls an image forming system, and the image forming system may comprise a first image forming apparatus arranged on a conveyance path of a recording medium, a second image forming apparatus arranged on the conveyance path at a position farther downstream than the first image forming apparatus in a conveyance direction of the recording medium, a first reading section arranged on the conveyance path between the first image forming apparatus and the second image forming apparatus, and reads the recording medium conveyed through the conveyance path, and a second reading section arranged on the conveyance path at a position farther downstream than the second image forming apparatus in the conveyance direction, and reads the recording medium conveyed through the conveyance path, and the image forming program causes a computer to perform a device control step of causing the first image forming apparatus to form an image on a first side of the recording medium and not to form an image on a second side opposite to the first side, and causing the second image forming apparatus to form an image on the second side of the recording medium and not to form an image on the first side, a first inspection step of detecting an abnormality of the first image forming apparatus based on image data output by the first reading section that reads the first side and the second side of the recording medium, and a second inspection step of detecting an abnormality of the second image forming apparatus based on image data output by the second reading section that reads the first side and the second side of the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a front view illustrating one example of an image forming system in one embodiment of the present invention;

FIG. 2 is a diagram schematically illustrating one example of the inner structure of a sheet feed device;

FIG. 3 is a diagram schematically illustrating the inner configuration of a first image forming apparatus;

FIG. 4 is a diagram schematically illustrating the inner configuration of a first inspection device;

FIG. 5 is a diagram schematically illustrating the inner configuration of an inverting device;

FIG. 6 is a diagram schematically illustrating the inner configuration of a post-processing apparatus;

FIG. 7 is a block diagram illustrating one example of the hardware configuration of the image forming system;

FIG. 8 is a block diagram illustrating one example of the functions of a CPU included in an image forming apparatus in the present embodiment;

FIG. 9 is a flowchart illustrating one example of a flow of a successive image forming process;

FIG. 10 is a flowchart illustrating one example of a flow of a first error process;

FIG. 11 is a flowchart illustrating one example of a flow of a second error process;

FIG. 12 is a flowchart illustrating one example of a flow of a first single forming process;

FIG. 13 is a flowchart illustrating one example of a flow of a second single forming process;

FIG. 14 is a diagram illustrating one example of an error determination table in a successive forming mode;

FIG. 15 is a diagram illustrating one example of an error determination table in the first single forming mode; and

FIG. 16 is a diagram illustrating one example of an error determination table in a second single forming mode.

### DETAILED DESCRIPTION

Hereinafter, one or more embodiments of the present invention will be described with reference to the drawings. However, the scope of the invention is not limited to the disclosed embodiments.

An image forming apparatus in embodiments of the present invention will be described below with reference to the drawings. In the following description, the same components are denoted by the same reference numerals. Their names and functions are the same. Therefore, a detailed description thereof will not be repeated.

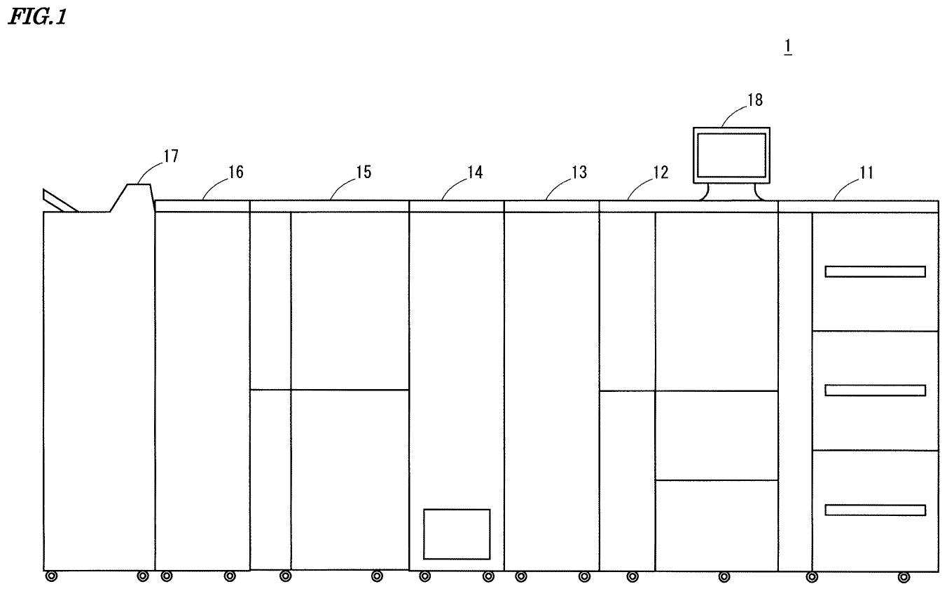

FIG. 1 is a front view illustrating one example of an image forming system in one embodiment of the present invention. With reference to FIG. 1, the image forming system 1 may comprise a sheet feed device 11, a first image forming apparatus 12, a first inspection device 13, an inverting device 14, a second image forming apparatus 15, a second inspection device 16 and a post-processing apparatus 17. A recording medium contained in the sheet feed device 11 is conveyed to the post-processing apparatus 17 along a conveyance path. A recording medium is a medium on which an image can be formed with a toner, and may comprise a sheet such as a paper and an Over Head Projector (OHP) sheet. In the present embodiment, a sheet is used as one example of a recording medium, by way of example.

The sheet feed device 11, the first image forming apparatus 12, the first inspection device 13, the inverting device 14, the second image forming apparatus 15, the second inspection device 16 and the post-processing apparatus 17 are arranged in this order along the conveyance path. The first image forming apparatus 12 and the second image forming apparatus 15 have the same configurations and functions. Further, the first inspection device 13 and the second inspection device 16 have the same configurations and functions. The first image forming apparatus 12 and the first inspection device 13 are described here by way of example unless otherwise specified.

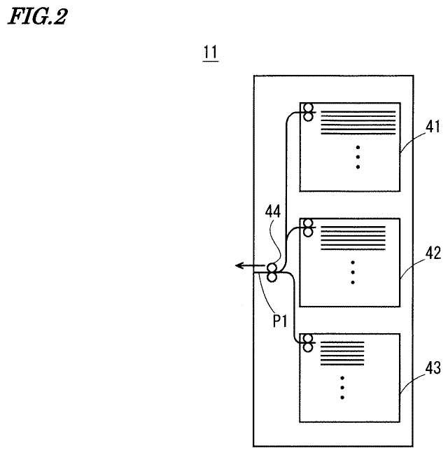

FIG. 2 is a diagram schematically illustrating one example of the inner structure of a sheet feed device. With reference to FIG. 2, the sheet feed device 11 may comprise a first sheet feed tray 41, a second sheet feed tray 42 and a third sheet feed tray 43. Each of the first sheet feed tray 41, the second sheet feed tray 42 and the third sheet feed tray 43 can contain a plurality of sheets. The types, sizes and orientations of sheets respectively contained in the first sheet feed tray 41, the second sheet feed tray 42 and the third sheet feed tray 43 may be the same or different. The sheet feed device 11 picks up sheets one by one from one of the first sheet feed tray 41, the second sheet feed tray 42 and the third sheet feed tray 43 and supplies the sheets to the first image forming apparatus 12. Each of the first sheet feed tray 41, the second sheet feed tray 42 and the third sheet feed tray 43 may comprise a pickup roller and a sorting roller and picks up sheets one by one in order from the top of a plurality of stacked sheets. A sheet picked up by the pickup roller and the sorting roller is conveyed by a feed roller 44. The feed roller 44 conveys the sheet along a conveyance path P1. The conveyance path P1 is the path connected to the first image forming apparatus 12. The sheet conveyed by the feed roller 44 travels along the conveyance path P1 and is supplied to the first image forming apparatus 12.

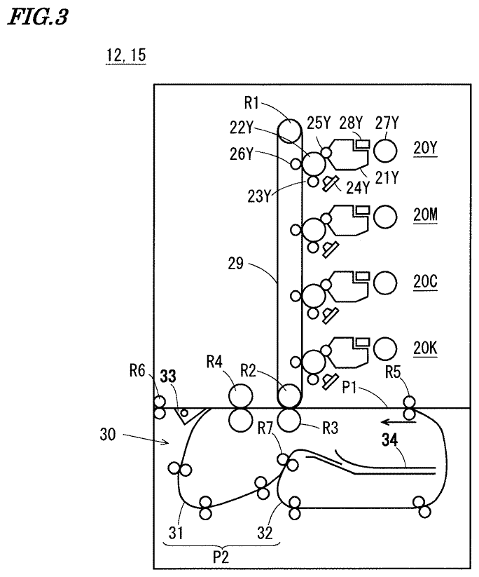

FIG. 3 is a diagram schematically illustrating the inner configuration of a first image forming apparatus. With reference to FIG. 3, the first image forming apparatus 12 may comprise image forming units 20Y, 20M, 20C, 20K corresponding to yellow, magenta, cyan and black, respectively. Here, “Y,” “M,” “C” and “K” represent yellow, magenta, cyan and black, respectively. Printing data pieces for yellow, magenta, cyan and black are respectively input to the image forming units 20Y, 20M, 20C, 20K. The only difference among the image forming units 20Y, 20M, 20C, 20K is the colors of toners used by the image forming units 20Y, 20M, 20C, 20K. Therefore, the image forming unit 20Y for forming an image in yellow will be described here. Hereinafter, for the sake of description, the horizontal direction orthogonal to a sheet conveyance direction is referred to as a forward-and-rearward direction. Further, the direction directed from the back surface to the front surface of the first image forming apparatus is referred to as a forward direction, and the direction directed from the front surface toward the back surface of the first image forming apparatus is referred to as a rearward direction.

The image forming unit 20Y may comprise a developing device 21Y, a photosensitive drum 22Y serving as an image bearing member, a charging roller 23Y, an exposure device 24Y, a primary transfer roller 26Y, a toner bottle 27Y and a toner hopper 28Y.

The toner bottle 27Y, the toner hopper 28Y and the developing device 21Y are arranged in this order on the path through which a toner is conveyed. The toner hopper 28Y is arranged immediately forward of the developing device 21Y. The toner is supplied through the toner conveyance path from the toner hopper 28Y to the developing device 21Y.

The developing device 21Y may comprise a developing roller 25Y. The developing roller 25Y has a built-in magnet roller, and holds a charged toner stored in the developing device 21Y using the effect of a magnetic force. The photosensitive drum 22Y has a cylindrical shape. Around the photosensitive drum 22Y, the charging roller 23Y, the exposure device 24Y, the developing roller 25Y and the primary transfer roller 26Y are arranged in this order in a rotation direction of the photosensitive drum 22Y.

The surface of the photosensitive drum 22Y is charged by the charging roller 23Y and then irradiated with a laser beam emitted by the exposure device 24Y. The exposure device 24Y forms an electrostatic latent image by exposing the portion corresponding to an image on the surface of the photosensitive drum 22Y. Thus, an electrostatic latent image is formed on the photosensitive drum 22Y. Subsequently, the developing device 21Y develops the electrostatic latent image formed on the photosensitive drum 22Y with the toner. Specifically, the toner held by the developing roller 25Y is placed on the electrostatic latent image formed on the photosensitive drum 22Y by the effect of an electric field force, so that a toner image is formed on the photosensitive drum 22Y. The toner image formed on the photosensitive drum 22Y is transferred by the primary transfer roller 26Y onto an intermediate transfer belt 29, serving as an image bearing member, by the effect of an electric field force.

The intermediate transfer belt 29 is suspended by a driving roller R1 and a driven roller R2 so as not to loosen. When the driving roller R1 is rotated in the clockwise direction in FIG. 1, the intermediate transfer belt 29 is rotated in the clockwise direction in the diagram at a predetermined speed. The driven roller R2 is rotated in the clockwise direction as the intermediate transfer belt 29 is rotated.

Thus, the image forming units 20Y, 20M, 20C, 20K transfer toner images onto the intermediate transfer belt 29 in this order. Timing for transferring toner images onto the intermediate transfer belt 29 by the respective image forming units 20Y, 20M, 20C, 20K is adjusted by detection of a reference mark provided on the intermediate transfer belt 29. Thus, the toner images in yellow, magenta, cyan and black are superimposed on the intermediate transfer belt 29.

A first receiving roller R5, a secondary transfer roller R3, a pair of fixing rollers R4 and a discharge roller R6 are arranged in this order in the conveyance direction along the conveyance path P1. The first receiving roller R5 receives a sheet conveyed from the sheet feed device 11 and conveys the sheet toward the secondary transfer roller R3.

The secondary transfer roller R3 is arranged opposite to the driven roller R2. Between the secondary transfer roller R3 and the driven roller R2, an electric field force is generated by the secondary transfer roller R3. Therefore, when a sheet conveyed along the conveyance path P1 passes between the secondary transfer roller R3 and the driven roller R2, a toner image formed on the intermediate transfer belt 29 is transferred onto the first side of the sheet due to the effect of an electric field force. The sheet to which the toner image has been transferred is conveyed to the pair of fixing rollers R4. The pair of fixing rollers R4 apply heat and pressure to the sheet passing between the pair of fixing rollers R4. Thus, the toner is fused and fixed to the first side of the sheet.

A first switching claw 33 is arranged on the conveyance path P1 between the pair of fixing rollers R4 and the discharge roller R6. The first image forming apparatus 12 may comprise a first inverting mechanism 30 below the conveyance path P1. The first inverting mechanism 30 may comprise a first inverting path P2, a first inverting roller R7 arranged on the first inverting roller R7, and a first retraction tray 34. The first switching claw 33 switches the sheet traveling direction to one of the direction toward the conveyance path P1 and the direction toward the first inverting path P2. With the sheet traveling direction switched to the direction toward the conveyance path P1 by the first switching claw 33, a sheet conveyed by the pair of fixing rollers R4 travels along the conveyance path P1 and received by the discharge roller R6. The discharge roller R6 receives the sheet conveyed by the pair of fixing rollers R4 and conveys the sheet. The sheet conveyed by the discharge roller R6 travels along the conveyance path P1 and is supplied to the first inspection device 13.

With the sheet traveling direction switched to the direction toward the first inverting path P2 by the first switching claw 33, a sheet conveyed by the pair of fixing rollers R4 travels along the first inverting path P2. The first inverting path P2 may comprise a first retraction path 31 and a first re-supply path 32. The first retraction path 31 is the path extending from a position farther upstream than the first switching claw 33 of the conveyance path P1 to the first retraction tray 34. The first re-supply path 32 is the path extending from the first retraction tray 34 to a position farther upstream than the first receiving roller R5 of the conveyance path P1.

With the sheet traveling direction switched to the direction toward the first inverting path P2 by the first switching claw 33, a sheet conveyed by the pair of fixing rollers R4 enters the first retraction path 31. A plurality of rollers may be arranged in the first retraction path 31 and convey the sheet. The sheet conveyed by the plurality of rollers of the first retraction path 31 travels along the first retraction path 31 and is received by the first inverting roller R7.

The first inverting roller R7 conveys the sheet toward the first retraction tray 34 by rotating in the forward direction. After conveying the sheet to the first retraction tray 34 by a predetermined amount, the first inverting roller R7 inverts the rotation direction and rotates in the opposite direction. When the first inverting roller R7 rotates in the opposite direction, the sheet partially contained in the first retraction tray 34 is conveyed in the direction opposite to the direction in which the sheet has been conveyed and enters the first re-supply path 32. A plurality of rollers may be arranged in the first re-supply path 32 and convey the sheet. The sheet conveyed by the plurality of rollers is conveyed along the first re-supply path 32 and enters the conveyance path P1.

The first receiving roller R5 receives the sheet conveyed along the first re-supply path 32 by the plurality of rollers of the first re-supply path 32 and conveys the sheet toward the secondary transfer roller R3. The upwardly directed side of the sheet that has passed through the first re-supply path 32 and is received by the first receiving roller R5 is a second side opposite to a first side, which is directed upwardly in a period during which the sheet is supplied from the sheet feed device 11 and conveyed through the conveyance path P1. Therefore, in a period during which the sheet that has been conveyed along the first re-supply path 32 is conveyed along the conveyance path P1 by the first receiving roller R5, an image is formed on the second side of the sheet.

In a case in which forming a full-color image, the first image forming apparatus 12 drives all of the image forming units 20Y, 20M, 20C, 20K. In a case in which forming a monochrome image, the first image forming apparatus 12 drives one of the image forming units 20Y, 20M, 20C, 20K. It is also possible to form an image by combining two or more of the image forming units 20Y, 20M, 20C, 20K.

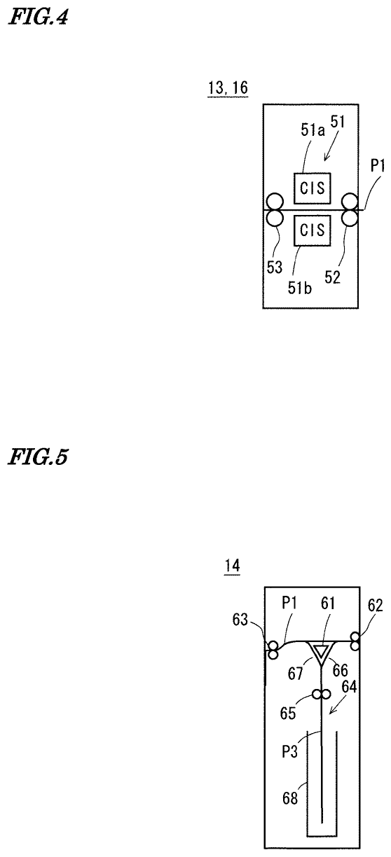

FIG. 4 is a diagram schematically illustrating the inner configuration of a first inspection device. With reference to FIG. 4, the first inspection device 13 may comprise a reading section 51, a first conveyance roller 52 and a second conveyance roller 53. The first conveyance roller 52 receives a sheet discharged from the first image forming apparatus 12 and conveys the sheet along the conveyance path P1. The second conveyance roller 53 receives the sheet conveyed by the first conveyance roller 52 and conveys the sheet. The sheet conveyed by the second conveyance roller 53 is conveyed along the conveyance path P1 and supplied to the inverting device 14.

The reading section 51 is arranged between the first conveyance roller 52 and the second conveyance roller 53. The reading section 51 may comprise a first Contact Image Sensor (CIS) 51a and a second Contact Image Sensor (CIS) 51b that are arranged with the conveyance path P1 interposed therebetween. Each of the first CIS 51a and the second CIS 51b is a contact image sensor and may comprise a plurality of optoelectronic transducers arranged side by side in a main scanning direction on the reading surface. Each of the first CIS 51a and the second CIS 51b is arranged such that its reading surface is directed toward the conveyance path P1. Therefore, in a period during which a sheet passes between the first CIS 51a and the second CIS 51b, the first CIS 51a and the second CIS 51b read the upper surface and the lower surface of the sheet, respectively.

FIG. 5 is a diagram schematically illustrating the inner configuration of an inverting device. With reference to FIG. 5, the inverting device 14 may comprise a second switching claw 61, a third conveyance roller 62 and a fourth conveyance roller 63. The third conveyance roller 62 and the fourth conveyance roller 63 are arranged on the conveyance path P1 in this order in the sheet conveyance direction. The third conveyance roller 62 receives a sheet conveyed from the first inspection device 13 and conveys the sheet toward the fourth conveyance roller 63.

The second switching claw 61 is arranged on the conveyance path P1 between the third conveyance roller 62 and the fourth conveyance roller 63. The inverting device 14 may comprise a second inverting mechanism 64 below the conveyance path P1. The second inverting mechanism 64 may comprise a second inverting path P3, a second inverting roller 65 arranged on the second inverting path P3, and a second retraction tray 68. The second switching claw 61 switches the sheet traveling direction to one of the direction toward the conveyance path P1 and the direction toward the second inverting path P3.

With the sheet traveling direction switched to the direction toward the conveyance path P1 by the second switching claw 61, a sheet conveyed by the third conveyance roller 62 travels along the conveyance path P1 to the fourth conveyance roller 63. The fourth conveyance roller 63 receives the sheet conveyed by the third conveyance roller 62 and conveys the sheet. The sheet conveyed by the third conveyance roller 62 travels along the conveyance path P1 and is supplied to the second image forming apparatus 15.

With the sheet traveling direction switched to the direction toward the second inverting path P3 by the second switching claw 61, a sheet conveyed by the third conveyance roller 62 travels along the second inverting path P3. The second inverting path P3 may comprise a second retraction path 66 extending from a branch point located farther upstream than the second switching claw 61 of the conveyance path P1 to the second inverting roller 65, a second re-supply path 67 extending from the second inverting roller 65 to a branch point located farther downstream than the second switching claw 61, and a path extending from a position at which the second retraction path 66 and the second re-supply path 67 merge to the second retraction tray 68.

With the sheet traveling direction switched to the direction toward the second inverting path P3 by the second switching claw 61, a sheet conveyed by the third conveyance roller 62 enters the second retraction path 66 and is received by the second inverting roller 65. The second inverting roller 65 conveys the sheet toward the second retraction tray 68 by rotating in the forward direction. After conveying the sheet to the second retraction tray 68 by a predetermined amount, the second inverting roller 65 inverts the rotation direction to rotate in the opposite direction. When the second inverting roller 65 rotates in the opposite direction, the sheet partially contained in the second retraction tray 68 is conveyed in the direction opposite to the direction in which the sheet has been conveyed and enters the second re-supply path 67. Further, the sheet conveyed by the second inverting roller 65 enters the conveyance path P1 and is conveyed to the fourth conveyance roller 63. The sheet conveyed by the fourth conveyance roller 63 travels along the conveyance path P1 and is supplied to the second image forming apparatus 15.

The upwardly directed side of the sheet that has passed through the second inverting path P3 and is received by the fourth conveyance roller 63 is a side opposite to a side, which is directed upwardly in a period during which the sheet is conveyed by the third conveyance roller 62.

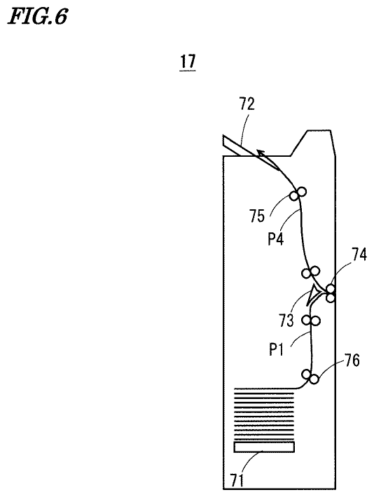

FIG. 6 is a diagram schematically illustrating the inner configuration of a post-processing apparatus. With reference to FIG. 6, the post-processing apparatus 17 may comprise a sheet ejection tray 71, a purge tray 72, a third switching claw 73, a second receiving roller 74, a purge roller 75 and a sheet ejection roller 76. The second receiving roller 74 and the sheet ejection roller 76 are arranged in this order on the conveyance path P1 in a sheet conveyance direction. The second receiving roller 74 receives a sheet conveyed from the second inspection device 16 and conveys the sheet toward the sheet ejection roller 76.

The third switching claw 73 is arranged on the conveyance path P1 between the second receiving roller 74 and the sheet ejection roller 76. In the post-processing apparatus 17, a purge path P4 branching from the conveyance path P1 is formed above the conveyance path P1. The third switching claw 73 switches the sheet traveling direction to one of the direction toward the conveyance path P1 and the direction toward the purge path P4.

With the sheet traveling direction switched to the direction toward the conveyance path P1 by the third switching claw 73, a sheet conveyed by the second receiving roller 74 travels along the conveyance path P1. The sheet ejection roller 76 receives the sheet conveyed by the second receiving roller 74 and conveys the sheet. The sheet conveyed by the sheet ejection roller 76 travels along the conveyance path P1 and is discharged onto the sheet ejection tray 71.

With the sheet traveling direction switched to the direction toward the purge path P4 by the third switching claw 73, a sheet conveyed by the second receiving roller 74 travels along the purge path P4. The purge path P4 is the path extending from a branch point located at a position farther upstream than the third switching claw 73 of the conveyance path P1 to the purge tray 72.

With the sheet traveling direction switched to the direction toward the purge path P4 by the third switching claw 73, a sheet conveyed by the second receiving roller 74 enters the purge path P4 and is received by the purge roller 75. The sheet conveyed by the purge roller 75 travels along the purge path P4 and is discharged to the purge tray 72.

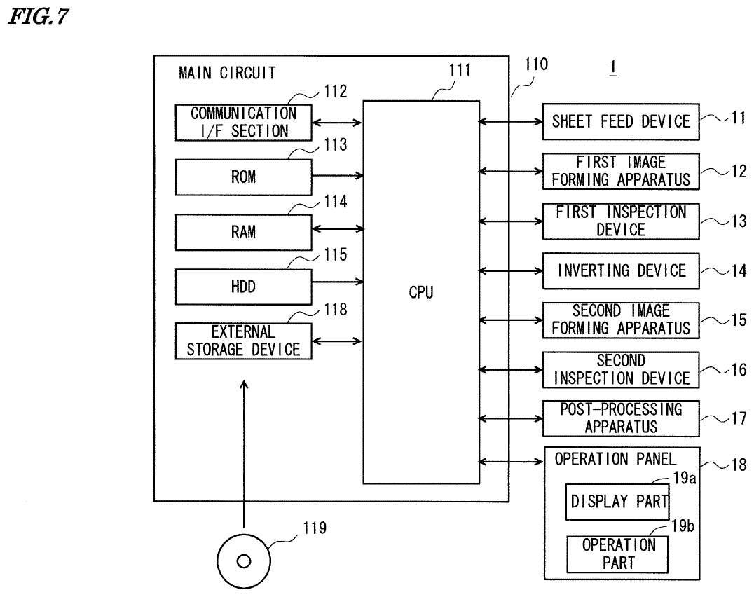

FIG. 7 is a block diagram illustrating one example of the hardware configuration of the image forming system. With reference to FIG. 7, the image forming system 1 may comprise a main circuit 110. The main circuit 110 is provided in any one of the sheet feed device 11, the first image forming apparatus 12, the first inspection device 13, the inverting device 14, the second image forming apparatus 15, the second inspection device 16 and the post-processing apparatus 17. Here, the main circuit 110 is provided in the first image forming apparatus 12 by way of example. The main circuit 110 may be provided in another housing different from the sheet feed device 11, the first image forming apparatus 12, the first inspection device 13, the inverting device 14, the second image forming apparatus 15, the second inspection device 16 and the post-processing apparatus 17.

The main circuit 110 may comprise a Central Processing Unit (CPU) 111 for controlling the image forming system 1 as a whole, a communication interface (I/F) section 112, a Read Only Memory (ROM) 113, a Random Access Memory (RAM) 114, a Hard Disc Drive (HDD) 115 that is used as a mass storage device and an external storage device 118. The CPU 111 is connected to the sheet feed device 11, the first image forming apparatus 12, the first inspection device 13, the inverting device 14, the second image forming apparatus 15, the second inspection device 16, the post-processing apparatus 17 and the operation panel 18 and controls the image forming system 1 as a whole.

The ROM 113 stores a program to be executed by the CPU 111 or data required for execution of the program. The RAM 114 is used as a work area when the CPU 111 executes the program. Further, the RAM 114 temporarily stores image data successively sent from a document reading section 130.

The operation panel 18 is provided in an upper portion of the housing of the first image forming apparatus 12. The operation panel 18 may comprise a display part 19a and an operation part 19b. The display part 19a is a Liquid Crystal Display Device (LCD), for example, and displays an instruction menu for a user, information about acquired image data, etc. As long as displaying images, an organic Electroluminescence (EL) display, for example, can be used instead of the LCD.

The operation part 19 may comprise a touch screen or hard keys. The touch screen detects a position designated by the user on the display surface of the display part 19a. The hard keys are contact switches, for example.

The communication I/F section 112 is an interface for connecting the image forming system 1 to a network. The communication I/F section 112 communicates with another computer or a data processing apparatus connected to the network using a communication protocol such as Transmission Control Protocol (TCP) or File Transfer Protocol (FTP). The network to which the communication I/F section 112 is connected is a Local Area Network (LAN), either wired or wireless. Further, the network is not limited to a LAN and may be a Wide Area Network (WAN), a Public Switched Telephone Network (PSTN), the Internet or the like.

The external storage device 118 is controlled by the CPU 111 and mounted with a Compact Disk Read Only Memory (CD-ROM) 118A or a semiconductor memory. While the CPU 111 executes a program stored in the ROM 113 by way of example in the present embodiment, the CPU 111 may control the external storage device 118, read a program to be executed by the CPU 111 from the CD-ROM 119 and store the read program in the RAM 114 for execution.

It is noted that a recording medium for storing a program to be executed by the CPU 111 is not limited to the CD-ROM 119. It may be a flexible disc, a cassette tape, an optical disc (Magnetic Optical Disc (MO)/Mini Disc (MD)/Digital Versatile Disc (DVD)), an IC card, an optical card, and a semiconductor memory such as a mask ROM and an Erasable Programmable ROM (EPROM). Further, the CPU 111 may download a program from a computer connected to a network and store the program in the HDD 115, or the computer connected to the network may write a program in the HDD 115. Then, the program stored in the HDD 115 may be loaded into the RAM 114 to be executed by the CPU 111. The program referred to here may comprise not only a program directly executable by the CPU 111 but also a source program, a compressed program, an encrypted program and the like.

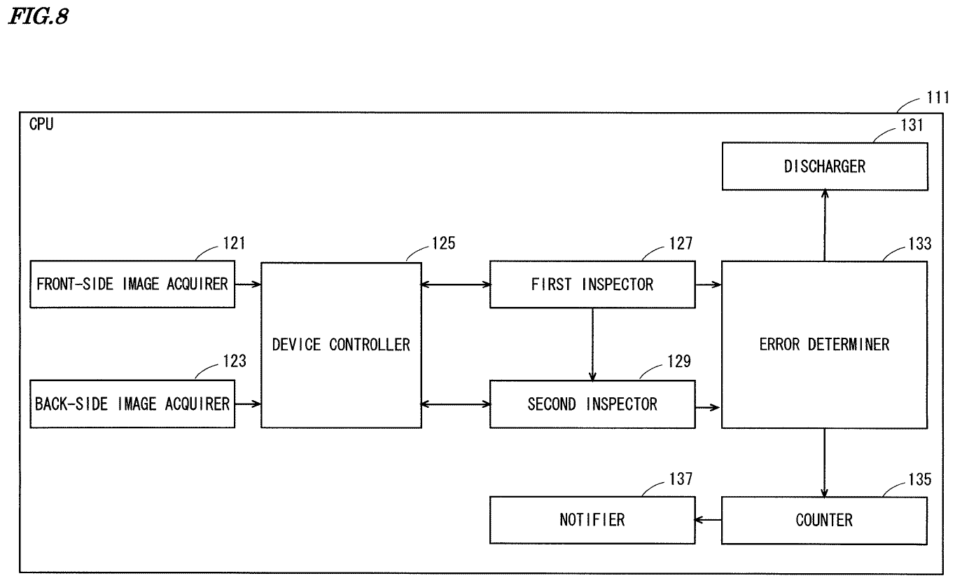

FIG. 8 is a block diagram illustrating one example of the functions of a CPU included in an image forming apparatus in the present embodiment. The functions illustrated in FIG. 8 are the functions implemented by the CPU 111 in a case in which the CPU 111 included in the image forming system 1 executes an image forming program stored in the ROM 113, the HDD 115 or the CD-ROM 119. With reference to FIG. 8, the CPU 111 may comprise a front-side image acquirer 121, a back-side image acquirer 123, a device controller 125, a first inspector 127, a second inspector 129, a discharger 131, an error determiner 133, a counter 135 and a notifier 137.

The front-side image acquirer 121 acquires front-side image data for formation of an image on the first side of a sheet. The back-side image acquirer 123 acquires back-side image data for formation of an image on the second side of a sheet. Image data subjected to image formation is specified by an instruction input to the operation part 19b by a user. The image data may be data received by the communication I/F section 112 from an external computer or may be data stored in the CD-ROM 119. The image data may comprise page data of a plurality of pages. The front-side image acquirer 121 acquires, as front-side image data, page data of odd-numbered pages among the page data of the plurality of pages, and outputs the front-side image data to the device controller 125. The back-side image acquirer 123 acquires, as back-side image data, page data of even-numbered pages among the page data of the plurality of pages, and outputs the back-side image data to the back-side image acquirer 123.

The device controller 125 controls the sheet feed device 11, the first image forming apparatus 12, the inverting device 14 and the second image forming apparatus 15 to cause the first image forming apparatus 12 and the second image forming apparatus 15 to form images on both sides of a sheet supplied from the sheet feed device 11. Here, a sheet have the first side and the second side opposite to the first side. The device controller 125 controls the sheet feed device 11, the first image forming apparatus 12, the inverting device 14 and the second image forming apparatus 15 in a plurality of control modes. The plurality of control modes may comprise a successive forming mode, a first single forming mode and a second single forming mode. The successive forming mode is a control mode in which the first image forming apparatus 12 forms an image on the first side of a sheet and the second image forming apparatus 15 forms an image on the second side of the sheet. The first single forming mode is a control mode in which the first image forming apparatus 12 forms images on both sides of a sheet and the second image forming apparatus 15 does not form an image on either side of the sheet. The second single forming mode is a control mode in which the second image forming apparatus 15 forms images on both sides of a sheet and the first image forming apparatus 12 does not form an image on either side of the sheet.

In the successive forming mode, the device controller 125 causes the sheet feed device 11 to feed a sheet, causes the first image forming apparatus 12 to form an image on the first side of the sheet, causes the inverting device 14 to invert the sheet, and causes the second image forming apparatus 15 to form an image on the second side of the sheet. The device controller 125 outputs front-side image data received from the front-side image acquirer 121 to the first image forming apparatus 12, and outputs back-side image data received from the back-side image acquirer 123 to the second image forming apparatus 15. Further, the device controller 125 outputs, to the first inspector 127 and the second inspector 129, a signal indicating that a control mode is the successive forming mode, the front-side image data and the back-side image data.

In the first single forming mode, the device controller 125 causes the sheet feed device 11 to feed a sheet, causes the first image forming apparatus 12 to form images on the first side and second side of the sheet, causes the inverting device 14 to convey the sheet along the conveyance path P1 and not to invert the sheet, and causes the second image forming apparatus 15 to let the sheet pass and not to form an image on the sheet. The device controller 125 outputs front-side image data received from the front-side image acquirer 121 and back-side image data received from the back-side image acquirer 123 to the first image forming apparatus 12, and outputs a passing instruction to the second image forming apparatus 15. Further, the device controller 125 outputs, to the first inspector 127 and the second inspector 129, a signal indicating that a control mode is the first single forming mode, the front-side image data and the back-side image data.

In the second single forming mode, the device controller 125 causes the sheet feed device 11 to feed a sheet, causes the first image forming apparatus 12 to let the sheet pass and not to form an image on the sheet, causes the inverting device 14 to convey the sheet along the conveyance path P1 and not to invert the sheet, and causes the second image forming apparatus 15 to form images on the first side and the second side of the sheet. The device controller 125 outputs a passing instruction to the first image forming apparatus 12, and outputs front-side image data received from the front-side image acquirer 121 and back-side image data received from the back-side image acquirer 123 to the second image forming apparatus 15. Further, the device controller 125 outputs, to the first inspector 127 and the second inspector 129, a signal indicating that a control mode is the second single forming mode, the front-side image data and the back-side image data.

The first inspector 127 controls the first inspection device 13 and acquires first inspection data output by the first CIS 51a of the first inspection device 13 that has read a sheet and second inspection data output by the second CIS 51b of the first inspection device 13 that has read the sheet. Based on the first inspection data and the second inspection data, the first inspector 127 detects an abnormality of the first image forming apparatus 12. The first inspector 127 detects an image formation defect from an image formed on a sheet. In a case in which an image formation defect is detected, the first inspector 127 detects an abnormality of the first image forming apparatus 12. The first inspector 127 outputs an inspection result to the device controller 125, the discharger 131 and the error determiner 133.

### <Successive Forming Mode>

In a case in which a control mode is the successive forming mode, the first CIS 51a of the first inspection device 13 reads the first side of a sheet and outputs first inspection data, and the second CIS 51b of the first inspection device 13 reads the second side of the sheet and outputs second inspection data. An image of front-side image data is formed on the first side of the sheet by the first image forming apparatus 12, and no image is formed on the second side of the sheet. In a case in which the control mode is the successive forming mode, the first inspector 127 detects the presence or absence of an image formation defect based on the front-side image data and the first inspection data. While a method of detecting an image formation defect is not specified, the first inspector 127 detects a portion that is present in the front-side image data but not present in the first inspection data and a portion that is not present in the front-side image data but is present in the first inspection data, for example. For example, the first inspector 127 detects an image formation defect by comparing the density of a difference image between the front-side image data and the first inspection data with a threshold value.

In a case in which the control mode is the successive forming mode, the first inspector 127 detects the presence or absence of an image formation defect based on second inspection data. In a case in which the control mode is the successive forming mode, no image is formed on the second side of the sheet. Therefore, the second inspection data may not comprise an image. However, in a period during which the sheet passes through the first image forming apparatus 12, an image formation defect in which a toner adheres to the sheet may occur.

In a case in which the thickness of a sheet is small or the basis weight of a sheet is relatively small, an image of front-side image data formed on the first side may be shown through and appear on the second side, and second inspection data may comprise part of the front-side image data. In this case, the first inspector 127 detects an image formation defect based on the second inspection data and the front-side image data. In a case in which the basis weight or the thickness of a sheet is set in advance in association with the sheet feed device 11, the first inspector 127 detects an image formation defect based on second inspection data and front-side image data.

### <First Single Forming Mode>

In a case in which a control mode is the first single forming mode, the first CIS 51a of the first inspection device 13 reads the second side of a sheet and outputs first inspection data, and the second CIS 51b of the first inspection device 13 reads the first side of the sheet and outputs second inspection data. In a case in which the control mode is the first single forming mode, an image of front-side image data is formed on the first side of the sheet and an image of back-side image data is formed on the second side of the sheet, by the first image forming apparatus 12. In a case in which the control mode is the first single forming mode, the first inspector 127 detects the presence or absence of an image formation defect based on the front-side image data and the second inspection data. For example, the first inspector 127 detects an image formation defect by comparing the density of a difference image between the front-side image data and the second inspection data with a threshold value. Further, in a case in which the control mode is the first single forming mode, the first inspector 127 detects the presence or absence of an image formation defect based on the back-side image data and the first inspection data. For example, the first inspector 127 detects an image formation defect by comparing the density of a difference image between the back-side image data and the first inspection data with a threshold value.

In a case in which the thickness of a sheet is small or the basis weight of a sheet is relatively small, an image of front-side image data formed on the first side may be shown through and appear on the second side, and an image of back-side image data formed on the second side may be shown through and appear on the first side. In this case, the first inspection data may comprise part of the front-side image data, and the second inspection data may comprise part of the back-side image data. Therefore, the first inspector 127 detects an image formation defect based on the first inspection data, and the front-side image data and the back-side image data and detects an image formation defect based on the second inspection data, and the front-side image data and the back-side image data.

### <Second Single Forming Mode>

In a case in which a control mode is the second single forming mode, the first CIS 51a of the first inspection device 13 reads the first side of a sheet and outputs first inspection data, and the second CIS 51b of the first inspection device 13 reads the second side of the sheet and outputs second inspection data. In a case in which the control mode is the second single forming mode, the first image forming apparatus 12 does not form an image on either one of the first side and the second side of the sheet. In a case in which the control mode is the second single forming mode, the first inspector 127 detects the presence or absence of an image formation defect based on each of the first inspection data and the second inspection data. The first inspection data and the second inspection data are data not including an image. However, in a period during which the sheet passes through the first image forming apparatus 12, an image formation defect in which a toner adheres to the first side or the second side of the sheet may occur.

The second inspector 129 controls the second inspection device 16 and acquires third inspection data output by the first CIS 51a of the second inspection device 16 that reads the sheet and fourth inspection data output by the second CIS 51b of the second inspection device 16 that reads the sheet. The second inspector 129 detects an abnormality of the second image forming apparatus 15 based on the third inspection data and the fourth inspection data. The second inspector 129 detects an image formation defect from an image formed on the sheet. In a case in which an image formation defect is detected, the second inspector 129 detects an abnormality of the second image forming apparatus 15. The second inspector 129 outputs an inspection result to the device controller 125, the discharger 131 and the error determiner 133.

### <Successive Forming Mode>

In a case in which a control mode is the successive forming mode, the first CIS 51a of the second inspection device 16 reads the second side of a sheet and outputs third inspection data, and the second CIS 51b of the second inspection device 16 reads the first side of the sheet and outputs fourth inspection data. An image of back-side image data is formed on the second side of a sheet by the second image forming apparatus 15, and no image is formed on the first side of the sheet. In a case in which the control mode is the successive forming mode, the second inspector 129 detects the presence or absence of an image formation defect based on the back-side image data and the third inspection data. For example, the second inspector 129 detects an image formation defect by comparing the density of a difference image between the back-side image data and the third inspection data with a threshold value.

The second inspector 129 acquires second inspection data from the first inspector 127 and detects the presence or absence of an image formation defect further based on the second inspection data. For example, the second inspector 129 changes a threshold value for detection of the presence or absence of an image formation defect based on first inspection data. In a case in which the thickness of a sheet is small, the basis weight of a sheet is relatively small, etc., an image of front-side image data formed on the first side may be shown through and appear on the second side, and the third inspection data may comprise part of an image of the front-side image data. For example, the higher the density of the front-side image data is, the lower the threshold value may be.

In a case in which the control mode is the successive forming mode, the second inspector 129 detects the presence or absence of an image formation defect based on the fourth inspection data and the first inspection data. In a case in which the control mode is the successive forming mode, no image is formed on the first side of the sheet by the second image forming apparatus 15. Therefore, the fourth inspection data is to be equal to the first inspection data. However, in a period during which the sheet pass through the second image forming apparatus 15, an image formation defect in which a toner adheres to the sheet may occur.

In a case in which the thickness of a sheet is small, the basis weight of a sheet is relatively small, etc., an image of the back-side image data formed on the second side may be shown through and appear on the first side, and the fourth inspection data may comprise part of an image of the back-side image data. In this case, the second inspector 129 detects an image formation defect based on the back-side image data in addition to the fourth inspection data and the second inspection data.

### <Second Single Forming Mode>

In a case in which a control mode is the second single forming mode, the first CIS 51a of the second inspection device 16 reads the second side of a sheet and outputs third inspection data, and the second CIS 51b reads the first side of the sheet and outputs fourth inspection data. In a case in which the control mode is the second single forming mode, an image of front-side image data is formed on the first side of a sheet and an image of back-side image data is formed on the second side of the sheet by the second image forming apparatus 15. When the control mode is the second single forming mode, the second inspector 129 detects the presence or absence of an image formation defect based on the front-side image data and the fourth inspection data. For example, the second inspector 129 detects an image formation defect by comparing the density of a difference image between the front-side image data and the fourth inspection data with a threshold value. Further, in a case in which the control mode is the second single forming mode, the second inspector 129 detects the presence or absence of an image formation defect based on the back-side image data and the third inspection data. For example, the second inspector 129 detects an image formation defect by comparing the density of a difference image between the back-side image data and the third inspection data with a threshold value.

In a case in which the thickness of a sheet is small, the basis weight of a sheet is relatively small, etc., an image of the front-side image data formed on the first side may be shown through and appear on the second side, and an image of the back-side image data formed on the second side may be shown through and appear on the first side. In this case, the third inspection data may comprise part of the front-side image data, and the fourth inspection data may comprise part of the back-side image data. Therefore, the second inspector 129 detects an image formation defect based on the third inspection data, and the front-side image data and the back-side image data and detects an image formation defect based on the fourth inspection data, and the front-side image data and the back-side image data.

### <First Single Forming Mode>

In a case in which a control mode is the first single forming mode, the first CIS 51a of the second inspection device 16 reads the second side of a sheet and outputs third inspection data, and the second CIS 51b reads the first side of the sheet and outputs fourth inspection data. In a case in which the control mode is the first single forming mode, an image of front-side image data is formed on the first side of a sheet by the first image forming apparatus 12, an image of back-side image data is formed on the second side of the sheet, and no image is formed either one of the first side and the second side of the sheet by the second image forming apparatus 15.

Therefore, the third inspection data is equal to first inspection data, and the fourth inspection data is equal to second inspection data. However, in a period during which the sheet passes through the second image forming apparatus 15, an image formation defect in which a toner adheres to the first side or the second side of the sheet may occur.

In a case in which the control mode is the first single forming mode, the second inspector 129 detects the presence or absence of an image formation defect based on the third inspection data and the first inspection data and detects the presence or absence of an image formation defect based on the fourth inspection data and the second inspection data.

The error determiner 133 determines the type of error based on detection results received from the first inspector 127 and the second inspector 129. The type of error may comprise information that specifies a device in which an image formation defect has occurred. In a case in which a detection result may comprise an image formation defect, the error determiner 133 outputs a discharge instruction to the discharger 131 and also outputs the type of error to the counter 135.

The discharger 131 controls the post-processing apparatus 17. In response to receiving the discharge instruction from the error determiner 133, the discharger 131 causes the post-processing apparatus 17 to switch the third switching claw 73 such that a sheet travels in the direction toward the purge path P4. Thus, a sheet having an image formation defect travels along the purge path P4 and is discharged to the purge tray 72.

In response to receiving the type of error from the error determiner 133, the counter 135 counts the number of image formation defects that have occurred in each of the first image forming apparatus 12 and the second image forming apparatus 15. The counter 135 updates a device classification table stored in the HDD 115. The device classification table may comprise records respectively associated with the first image forming apparatus 12 and the second image forming apparatus 15. A record included in the device classification table associates device identification information for identifying a device with the number of image formation defects.

In accordance with a user's operation of inputting to the operation part 19b, the notifier 137 displays the device classification table stored in the HDD 115 on the display part 19a. The user can easily determine whether an image formation defect is caused by the first image forming apparatus 12 or the second image forming apparatus 15 by referring to the device classification table. Further, the notifier 137 may notify an administrator of the image forming system 1 at a point in time at which the number of image formation defects becomes equal to or larger than a predetermined threshold value. For example, the notifier 137 sends an email or the like. An email may comprise the device classification table.

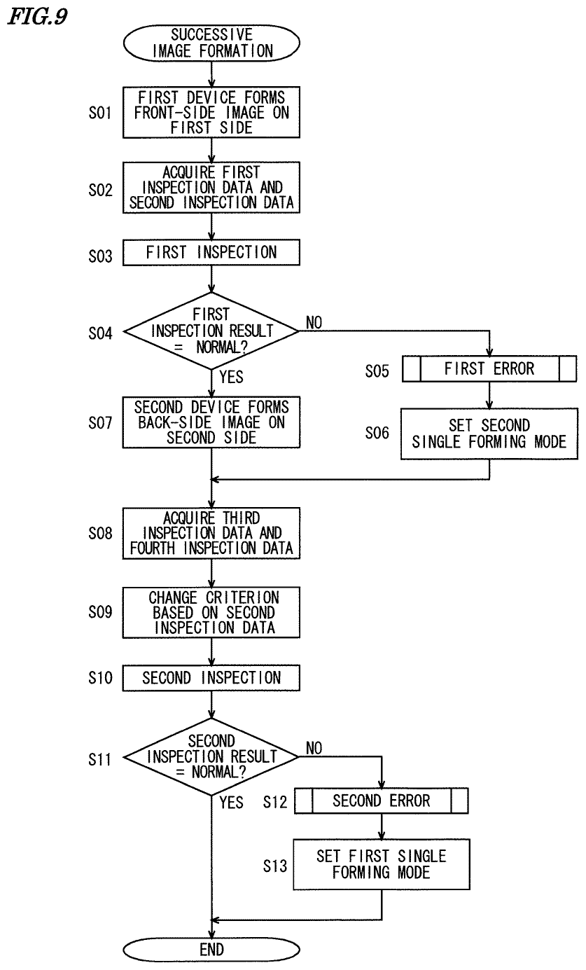

FIG. 9 is a flowchart illustrating one example of a flow of a successive image forming process. An image forming process in the successive forming mode is a process executed by the CPU 111 included in the image forming system 1 when the CPU 111 executes the image forming program stored in the ROM 113, the HDD 115 or the CD-ROM 119. The image forming process in the successive forming mode is a process to be executed by the CPU 111 in a case in which a control mode is set to the successive forming mode.

With reference to FIG. 9, the CPU 111 forms a front-side image on the first side of a sheet by a first device (step S01), and the process proceeds to the step S02. The first device is the first image forming apparatus 12. The CPU 111 transmits front-side image data to the first image forming apparatus 12. The first image forming apparatus 12 forms a front-side image of the front-side image data on the first side of the sheet.

In the step S02, first inspection data and second inspection data are acquired, and the process proceeds to the step S03. The first inspection data output by the first CIS 51a of the first inspection device 13 that reads the first side of the sheet and the second inspection data output by the second CIS 51b of the first inspection device 13 that reads the second side of the sheet are acquired.

In the step S03, a first inspection process is executed. The first inspection process may comprise inspection using the first inspection data and the front-side image data, and inspection using the second inspection data. It is determined that an image formation error has occurred in a case in which a group of a predetermined number, equal to or larger than a predetermined number, of adjacent pixels are present in difference data representing a difference between the first inspection data and the surface image data. Further, it is determined that an image formation defect has occurred in a case in which a group of a predetermined number, equal to or larger than a predetermined threshold value, of adjacent pixels are present in the second inspection data.

In the step S04, the process branches according to a result of the first inspection process in the step S03. If the first inspection result indicates normality, the process proceeds to the step S07. If not and the first inspection result represents an image formation error, the process proceeds to the step S05. In the step S05, a first error process is executed, and the process proceeds to the step S06. Although details of the first error process will be described below, the first error process is a process executed in a case in which an abnormality is detected in the first image forming apparatus 12. In the step S06, a control mode is set to the second single forming mode, and the process proceeds to the step S08.

In the step S07, a front-side image is formed on the second side of a sheet by a second device, and the process proceeds to the step S08. The second device is the second image forming apparatus 15. The CPU 111 transmits back-side image data to the second image forming apparatus 15. The second image forming apparatus 15 forms the back-side image of the back-side image data on the second side of the sheet.

In the step S08, third inspection data and fourth inspection data are acquired, and the process proceeds to the step S09. The front side and backside of a sheet supplied from the inverting device 14 to the second inspection device 16 are inverted by the inverting device 14. The third inspection data that is output by the first CIS 51a of the second inspection device 16 that reads the second side of the sheet and the fourth inspection data that is output by the second CIS 51b of the second inspection device 16 that reads the first side of the sheet are acquired.

In the step S09, a criterion is changed based on the second inspection data. A threshold value used for a second inspection process to be executed in the next step S10 is changed based on the second inspection data. In the step S10, the second inspection process is executed. The second inspection process may comprise inspection using the third inspection data and the back-side image data, and inspection using the fourth inspection data and the first inspection data. In a case in which a group of a predetermined number, equal to or larger than a predetermined threshold value, of adjacent pixels are present in the difference data representing a difference between the third inspection data and the back-side image data, it is determined that an image formation error has occurred. Further, in a case in which a group of a predetermined number, equal to or larger than a predetermined threshold value, of adjacent pixels are present in the difference data between the fourth inspection data and the first inspection data, it is determined that an image formation defect has occurred.

In the step S11, the process branches according to a result of the second inspection process in the step S10. If the second inspection result indicates normality, the process ends. If not, and it represents an image formation defect, the process proceeds to the step S12. In step S12, a second error process is executed, and the process proceeds to step S13. While details of the second error process will be described below, the second error process is a process to be executed in a case in which an abnormality is detected in the second image forming apparatus 15. In the step S13, the control mode is set to the first single forming mode, and the process ends.

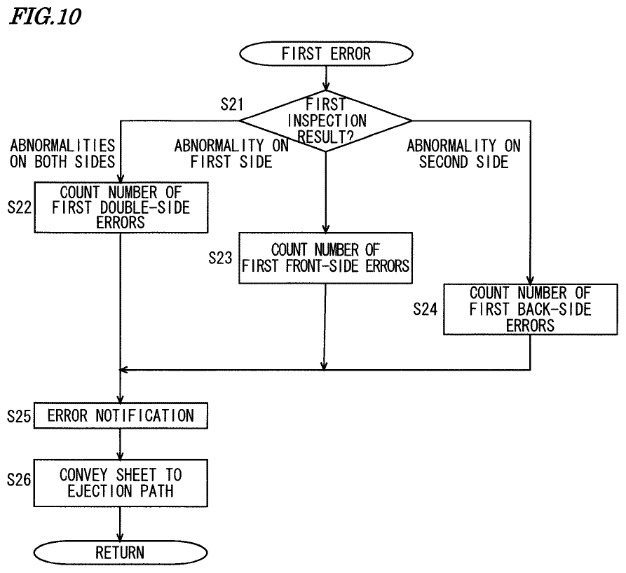

FIG. 10 is a flowchart illustrating one example of a flow of a first error process. The first error process is a process executed in the step S05 of FIG. 9. With reference to FIG. 10, the process branches according to a first inspection result (step S21). In a case in which the first inspection result indicates that image formation abnormalities are detected on both sides of a sheet, the process proceeds to the step S22. In a case in which the first inspection result indicates that an image formation abnormality is detected on the first side of the sheet and an image formation abnormality is not detected on the second side of the sheet, the process proceeds to the step S23. In a case in which the first inspection result indicates that an image forming abnormality is detected on the second side of the sheet and an image forming abnormality is not detected on the first side of the sheet, the process proceeds to the step S24.

In the step S22, the number of first double-side errors is counted, and the process proceeds to the step S25. The number of first double-side errors indicates the number of image formation defects that have occurred respectively on the first side and the second side in the first image forming apparatus 12. An image formation defect on the first side is detected based on the first inspection data, and an image formation defect on the second side is detected based on the second inspection data.

In the step S23, the number of first front-side errors is counted, and the process proceeds to the step S25. The number of first front-side errors indicates the number of image formation defects that have occurred on the first side in the first image forming apparatus 12.

In the step S24, the number of the first back-side errors is counted, and the process proceeds to the step S25. The number of first back-side errors indicates the number of image formation defects that have occurred on the second side in the first image forming apparatus 12.

In the step S25, the administrator of the image forming system 1 is notified of an error, and the process proceeds to the step S26. The content of the error is displayed on the display part 19a. The administrator may be notified of an occurrence of an image formation defect through an e-mail or the like.

In the step S26, it is set that the sheet is to be conveyed to an ejection path, and the process returns to the successive image forming process. Specifically, the CPU 111 outputs an instruction for conveyance of the sheet without inversion to the inverting device 14, outputs an instruction for conveyance of the sheet without image formation to the second image forming apparatus 15, and outputs an instruction for ejection of the sheet to the purge tray 72 to the post-processing apparatus 17.

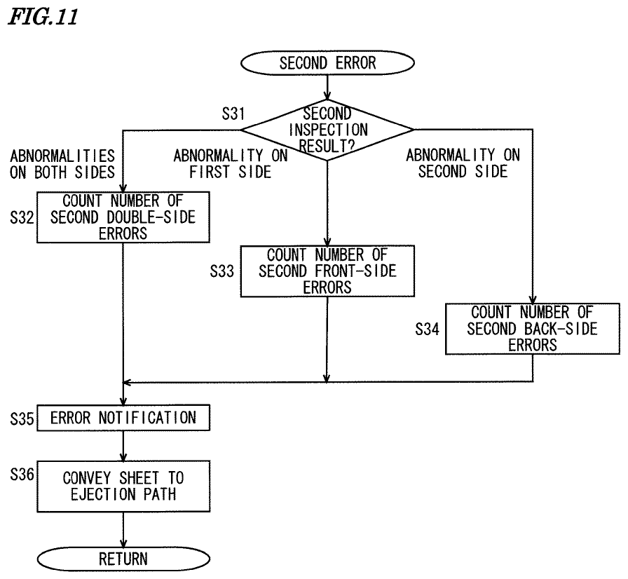

FIG. 11 is a flowchart illustrating one example of a flow of a second error process. The second error process is a process executed in the step S12 of FIG. 9. With reference to FIG. 11, the process branches according to a second inspection result (step S31). In a case in which the second inspection result indicates detection of an image formation abnormality on both sides of a sheet, the process proceeds to the step S32. In a case in which the second inspection result indicates detection of an image formation abnormality on the first side of the sheet and detection of no image formation abnormality on the second side, the process proceeds to the step S33. In a case in which the second inspection result indicates detection of an image formation abnormality on the second side of the sheet and detection of no image formation abnormality on the first side, the process proceeds to the step S34.

In the step S32, the number of second double-side errors is counted, and the process proceeds to the step S35. The number of second double-side errors indicates the number of image formation defects that have respectively occurred on the first side and the second side in the second image forming apparatus 15. An image formation defect on the first side is detected based on fourth inspection data, and an image formation defect on the second side is detected based on third inspection data.

In the step S33, the number of second front-side errors is counted, and the process proceeds to the step S35. The number of second front-side errors indicates the number of image formation defects that have occurred on the first side in the second image forming apparatus 15.

In the step S34, the number of second back-side errors is counted, and the process proceeds to the step S35. The number of second back-side errors indicates the number of image formation defects on the second side in the second image forming apparatus 15.

In the step S35, the administrator of the image forming system 1 is notified of an error, and the process proceeds to the step S36. The content of the error is displayed on the display part 19a. The administrator may be notified of an occurrence of an image formation defect through an e-mail or the like.

In the step S36, it is set that the sheet is to be conveyed to the ejection path, and the process returns to the successive image forming process. Specifically, the CPU 111 outputs an instruction for ejection of the sheet to the purge tray 72 to the post-processing apparatus 17.

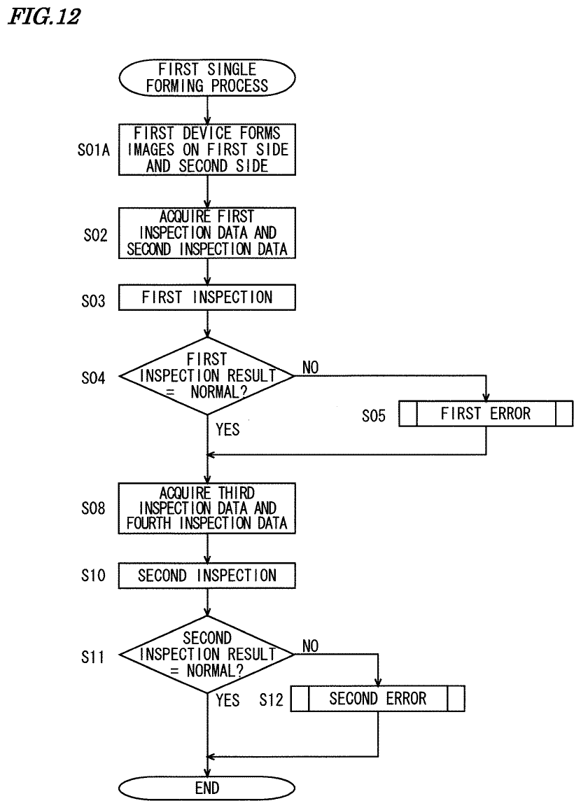

FIG. 12 is a flowchart illustrating one example of a flow of a first single forming process. The first single forming process is a process executed in a case in which a control mode is set to the first single forming mode. With reference to FIG. 12, differences from the successive image forming process illustrated in FIG. 9 are that the step S01 is changed to the step S01A, and that the steps S06, S07, S09 and S13 are not performed.

In the step S01A, the CPU 111 forms images on the first side and the second side of a sheet by the first device, and the process proceeds to the step S03. The first device is the first image forming apparatus 12. The CPU 111 transmits front-side image data and back-side image data to the first image forming apparatus 12. The first image forming apparatus 12 forms a front-side image of the front-side image data on the first side of the sheet and forms a back-side image of the back-side image data on the second side of the sheet.

In the step S04, the process branches according to a result of the first inspection process in the step S03. If the first inspection result indicates normality, the process proceeds to the step S08. If not, and the first inspection result indicates an image formation error, the process proceeds to the step S05. In the step S05, the first error process illustrated in FIG. 10 is executed, and the process proceeds to the step S08.

In the step S08, third inspection data and fourth inspection data are acquired, and the process proceeds to the step S10. In the step S10, the second inspection process is executed, and the process proceeds to the step S11. In the step S11, the process branches according to a result of the second inspection process in the step S10. If the second inspection result indicates normality, the process ends. If not, and it represents an image formation defect, the process proceeds to the step S12. In the step S12, the second error process illustrated in FIG. 11 is executed, and the process ends.

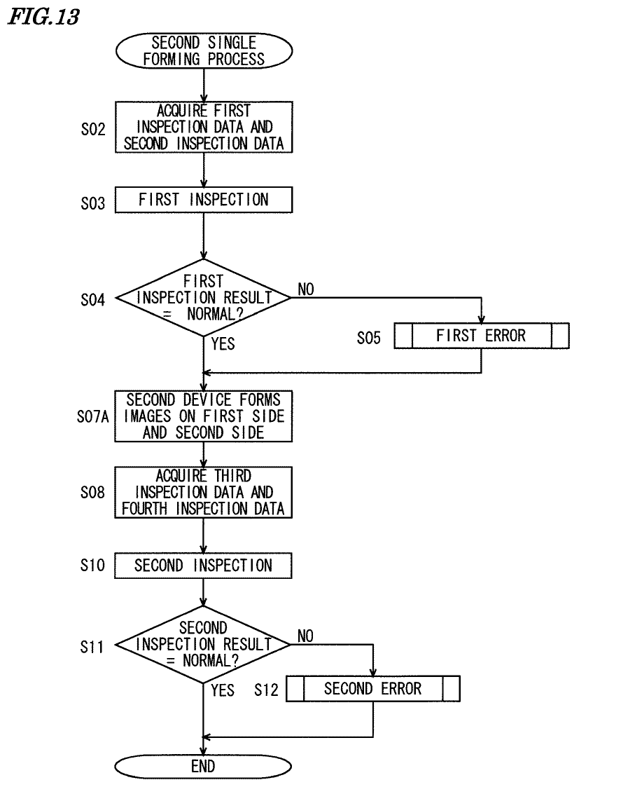

FIG. 13 is a flowchart illustrating one example of a flow of a second single forming process. The second single forming process is a process executed in a case in which a control mode is set to the second single forming mode. With reference to FIG. 13, differences from the successive image forming process illustrated in FIG. 9 are that the step S07 is changed to the step S07A, and the steps S01, S06, S09 and S13 are not performed. When a control mode is the second single forming mode, the first image forming apparatus 12 conveys a sheet supplied from the sheet feed device 11 as it is without forming an image on the sheet.

The CPU 111 acquires first inspection data and second inspection data (step S02), and the process proceeds to the step S03. The first inspection data output by the first CIS 51a of the first inspection device 13 that reads the first side of the sheet and the second inspection data output by the second CIS 51b of the first inspection device 13 that reads the second side of the sheet are acquired.

In the step S03, the first inspection process is executed, and the process proceeds to the step S04. In the step S04, the process branches according to a result of the first inspection process in the step S03. If the first inspection result indicates normality, the process proceeds to the step S07A. If not, and the first inspection result indicates an image formation error, the process proceeds to the step S05. In the step S05, the first error process illustrated in FIG. 10 is executed, and the process proceeds to the step S07A.

In the step S07A, images are formed on the first and second sides of the sheet by the second device, and the process proceeds to the step S08. The second device is the second image forming apparatus 15. The CPU 111 transmits front-side image data and back-side image data to the second image forming apparatus 15. The second image forming apparatus 15 forms a front-side image of the front-side image data on the first side of the sheet and forms a back-side image of the back-side image data on the second side of the sheet.

In the step S08, third inspection data and fourth inspection data are acquired, and the process proceeds to the step S10. The front side and back side of the sheet supplied from the second image forming apparatus 15 to the second inspection device 16 are inverted by the second image forming apparatus 15. The third inspection data output by the first CIS 51a of the second inspection device 16 that reads the second side of the sheet and the fourth inspection data output by the second CIS 51b of the second inspection device 16 that reads the first side of the sheet are acquired.

In the step S10, the second inspection process is executed, and the process proceeds to the step S11. In the step S11, the process branches according to a result of the second inspection process in the step S10. If the second inspection result indicates normality, the process ends. If not, and it represents an image formation defect, the process proceeds to the step S12. In the step S12, the second error process illustrated in FIG. 11 is executed, and the process ends.

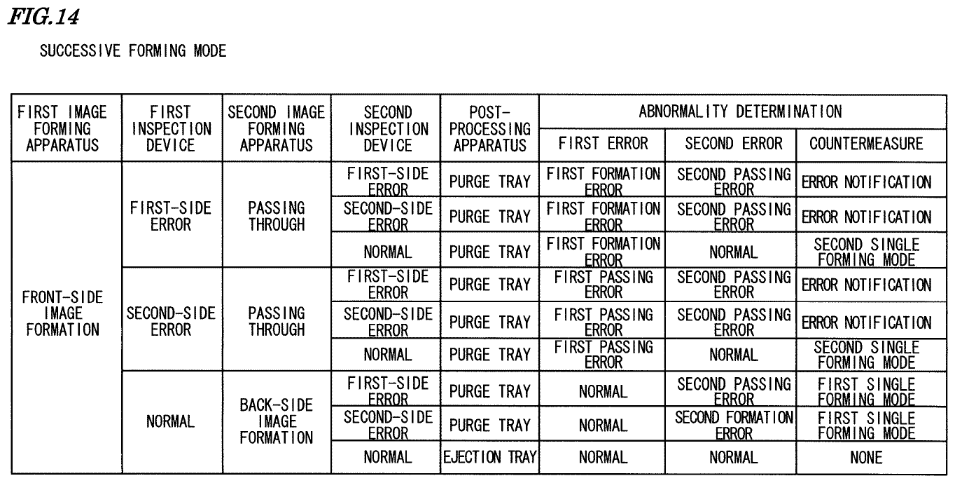

FIG. 14 is a diagram illustrating one example of an error determination table in a successive forming mode. With reference to FIG. 14, the error determination table in the successive forming mode may comprise the respective operation states of the first image forming apparatus 12, the first inspection device 13, the second image forming apparatus 15, the second inspection device 16 and the post-processing apparatus 17, and abnormality determination. The abnormality determination may comprise a first error, a second error and a countermeasure. The first error indicates the state of the first image forming apparatus 12, and the second error indicates the state of the second image forming apparatus 15.

When a control mode is the successive forming mode, in the first image forming apparatus 12, a front-side image of front-side image data is formed on the first side of a sheet, and no image is formed on the second side of the sheet. In a case in which an image formation abnormality is detected by inspection using first inspection data in the first inspection device 13, it is determined that a first-side error has occurred. The first-side error in this case indicates that an abnormality has occurred in formation of the front-side image by the first image forming apparatus 12. Further, in a case in which an image formation abnormality is detected by inspection using second inspection data in the first inspection device 13, it is determined that a second-side error has occurred. The second-side error in this case indicates that an abnormality has occurred because a sheet has passed through the first image forming apparatus 12. Further, in a case in which an image formation abnormality is not detected in either one of inspection using first inspection data and inspection using second inspection data in the first inspection device 13, it is determined that inspection results indicate normality.

When the control mode is the successive forming mode, in the second image forming apparatus 15, a back-side image of back-side image data is formed on the second side of a sheet, and no image is formed on the first side of the sheet. In a case in which an image formation abnormality is detected by inspection using fourth inspection data in the second inspection device 16, it is determined that a first-side error has occurred. The first-side error in this case indicates that an abnormality has occurred because a sheet has passed through the second image forming apparatus 15. Further, in a case in which an image formation abnormality is detected by inspection using third inspection data in the second inspection device 16, it is determined that a second-side error has occurred. The second-side error in this case indicates that an abnormality has occurred in formation of the back-side image by the second image forming apparatus 15. Further, in a case in which an image formation abnormality is not detected in either one of inspection using third inspection data and inspection using fourth inspection data in the second inspection device 16, it is determined that inspection results indicate normality.

In a case in which a result of inspection by the first inspection device 13 indicates a first-side error or a second-side error or a case in which a result of inspection by the second inspection device 16 indicates a first-side error or a second-side error, the post-processing apparatus 17 discharges the sheet to the purge tray 72. In a case in which the result of inspection by the first inspection device 13 indicates normality and the result of inspection by the second inspection device 16 indicates normality, the post-processing apparatus 17 discharges the sheet to the sheet ejection tray 71.

In abnormality determination, an image formation abnormality that has occurred in the first image forming apparatus 12 is indicated as a first error, an image formation abnormality that has occurred in the second image forming apparatus 15 is indicated as a second error, and an operation of the image forming system 1 is indicated as a countermeasure. The first error may comprise a first formation error and a first passing error. The first formation error indicates that an abnormality has occurred in formation of a front-side image by the first image forming apparatus 12. The first passing error indicates that an abnormality has occurred because a sheet has passed through the first image forming apparatus 12. Further, the second error may comprise a second formation error and a second passing error. The second formation error indicates that an abnormality has occurred in formation of a back-side image by the second image forming apparatus 15. The second passing error indicates that an abnormality has occurred because a sheet has passed through the second image forming apparatus 15.

As a countermeasure, an operation of the image forming system 1 in a case in which any of a first formation error, a first passing error, a second formation error and a second passing error has occurred is indicated. In a case in which any one of a first formation error and a first passing error is detected in the first image forming apparatus 12, and a second passing error is detected in the second inspection device 16, notification is made that an error has occurred. In a case in which any one of a first formation error and a first passing error is detected in the first image forming apparatus 12, and a second passing error is not detected in the second inspection device 16, a control mode is switched to the second single mode. In a case in which either one of a first formation error and a first passing error is not detected in the first image forming apparatus 12, and a second passing error or a second formation error is detected in the second inspection device 16, a control mode is switched to the first single mode. In a case in which either one of a first formation error and a first passing error is not detected in the first image forming apparatus 12, and either one of a second passing error and a second formation error is detected in the second inspection device 16, the successive forming mode is maintained as a control mode. In abnormality determination, in a case in which an error notification is indicated as a countermeasure, notification is made in regard to a control mode and the content of a first error and a second error.

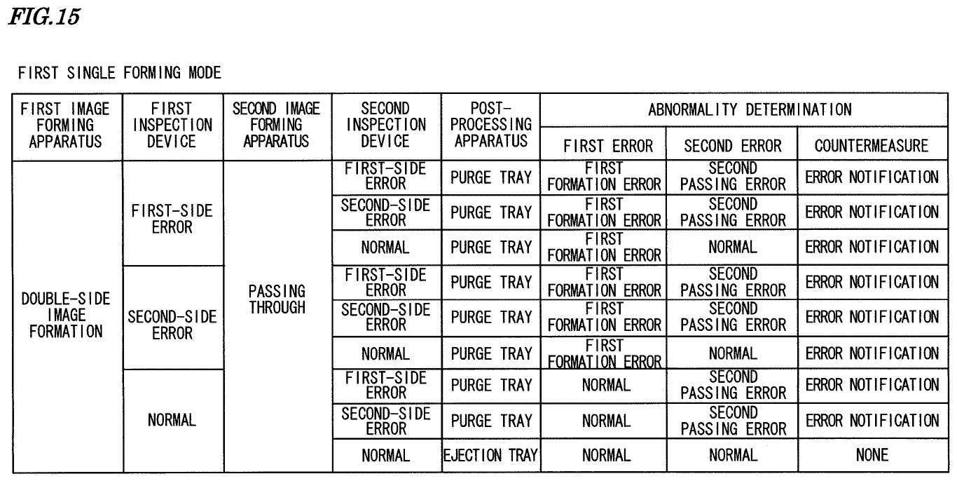

FIG. 15 is a diagram illustrating one example of an error determination table in the first single forming mode. With reference to FIG. 15, when a control mode is the first single forming mode, in the first image forming apparatus 12, a front-side image of front-side image data is formed on the first side of a sheet, and a back-side image of back-side image data is formed on the second side of the sheet. In a case in which an image formation abnormality is detected by inspection using first inspection data in the first inspection device 13, it is determined that a first-side error has occurred. The first-side error in this case indicates that an abnormality has occurred in formation of the front-side image by the first image forming apparatus 12. Further, in a case in which an image formation abnormality is detected by inspection using second inspection data in the first inspection device 13, it is determined that a second-side error has occurred. The second-side error in this case indicates that an abnormality has occurred in formation of a back-side image by the first image forming apparatus 12. Further, in a case in which an image formation abnormality is not detected in either one of inspection using first inspection data and inspection using second inspection data in the first inspection device 13, it is determined that inspection results indicate normality.

When the control mode is the first single forming mode, no image is formed on the first side and the second side of a sheet in the second image forming apparatus 15. In a case in which an image formation abnormality is detected by inspection using fourth inspection data in the second inspection device 16, it is determined that a first-side error has occurred. The first-side error in this case indicates that an abnormality has occurred because a sheet has passed through the second image forming apparatus 15. Further, in a case in which an image formation abnormality is detected by inspection using fourth inspection data in the second inspection device 16, it is determined that a second-side error has occurred. The second-side error in this case indicates that an abnormality has occurred because a sheet has passed through the second image forming apparatus 15. Further, in a case in which an image formation abnormality is not detected in either one of inspection using third inspection data and inspection using fourth inspection data in the second inspection device 16, it is determined that inspection results indicate normality.

In a case in which a result of inspection by the first inspection device 13 indicates a first-side error or a second-side error or a case in which a result of inspection by the second inspection device 16 indicates a first-side error or a second-side error, the post-processing apparatus 17 discharges a sheet to the purge tray 72. In a case in which a result of inspection by the first inspection device 13 indicates normality and a result of inspection by the second inspection device 16 indicates normality, the post-processing apparatus 17 discharges a sheet to the sheet ejection tray 71.

In abnormality determination, an image formation abnormality that has occurred in the first image forming apparatus 12 is indicated as a first error, an image formation abnormality that has occurred in the second image forming apparatus 15 is indicated as a second error, and an operation of the image forming system 1 is indicated as a countermeasure. The first error may comprise a first formation error. The first formation error indicates that an abnormality has occurred in formation of a front-side image or formation of a back-side image by the first image forming apparatus 12. Further, the second error may comprise a second passing error. The second passing error indicates that an abnormality has occurred because a sheet has passed through the second image forming apparatus 15.

A countermeasure indicates an operation of the image forming system 1 in a case in which any one of a first formation error and a second passing error has occurred. In a case in which a first formation error is detected in the first image forming apparatus 12 or a case in which a second passing error is detected in the second inspection device 16, notification is made that an error has occurred. In a case in which a first formation error is not detected in the first image forming apparatus 12, and a second passing error is not detected in the second inspection device 16, the first single forming mode is maintained as a control mode. In abnormality determination, in a case in which an error notification is indicated as a countermeasure, notification is made in regard to a control mode and the content of a first error and a second error.

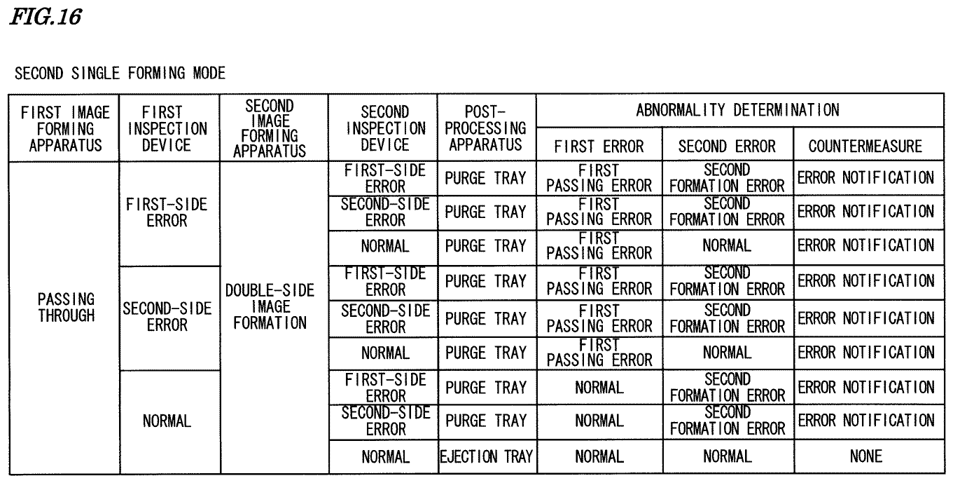

FIG. 16 is a diagram illustrating one example of an error determination table in a second single forming mode. With reference to FIG. 16, when a control mode is the second single forming mode, no image is formed on the first side and the second side of a sheet in the first image forming apparatus 12. In a case in which an image formation abnormality is detected by inspection using first inspection data in the first inspection device 13, it is determined that a first-side error has occurred. The first-side error in this case indicates that an abnormality has occurred because a sheet has passed through the first image forming apparatus 12. Further, in a case in which an image formation abnormality is detected by inspection using second inspection data in the first inspection device 13, it is determined that a second-side error has occurred. The second-side error in this case indicates that an abnormality has occurred because a sheet has passed through the first image forming apparatus 12. Further, in a case in which an image formation abnormality is not detected in either one of inspection using first inspection data and inspection using second inspection data in the first inspection device 13, it is determined that inspection results indicate normality.

When a control mode is the second single forming mode, in the second image forming apparatus 15, a front-side image of front-side image data is formed on the first side of a sheet, and a back-side image of back-side image data is formed on the second side of the sheet. In a case in which an image formation abnormality is detected by inspection using fourth inspection data in the second inspection device 16, it is determined that a first-side error has occurred. The first-side error in this case indicates that an abnormality has occurred in formation of the front-side image by the second image forming apparatus 15. Further, in a case in which an image formation abnormality is detected by inspection using third inspection data in the second inspection device 16, it is determined that a second-side error has occurred. The second-side error in this case indicates that an abnormality has occurred in formation of the back-side image by the second image forming apparatus 15. Further, in a case in which an image formation abnormality is not detected in either one of inspection using third inspection data and inspection using fourth inspection data in the second inspection device 16, it is determined that inspection results indicate normality.

In a case in which a result of inspection by the first inspection device 13 indicates a first-side error or a second-side error or a case in which a result of inspection by the second inspection device 16 indicates a first-side error or a second-side error, the post-processing apparatus 17 discharges a sheet to the purge tray 72. In a case in which a result of inspection by the first inspection device 13 indicates normality and a result of inspection by the second inspection device 16 indicates normality, the post-processing apparatus 17 discharges a sheet to the sheet ejection tray 71.

In abnormality determination, an image formation abnormality that has occurred in the first image forming apparatus 12 is indicated as a first error, an image formation abnormality that has occurred in the second image forming apparatus 15 is indicated as a second error, and an operation of the image forming system 1 is indicated as a countermeasure. The first error may comprise a first passing error. The first passing error indicates that an abnormality has occurred because a sheet has passed through the first image forming apparatus 12. Further, the second error may comprise a second formation error. The second formation error indicates that an abnormality has occurred in formation of a front-side image or formation of a back-side image by the second image forming apparatus 15.

As a countermeasure, an operation of the image forming system 1 in a case in which any one of a first passing error and a second forming error has occurred is indicated. In a case in which a first passing error is detected in the first image forming apparatus 12 or a case in which a second forming error is detected in the second inspection device 16, notification is made that an error has occurred. In a case in which a first passing error is not detected in the first image forming apparatus 12 and a second forming error is not detected in the second inspection device 16, the second single mode is maintained as a control mode. In abnormality determination, in a case in which an error notification is indicated as a countermeasure, notification is made in regard to a control mode and the content of a first error and a second error.

As described above, the image forming system 1 in the present embodiment may comprise the first image forming apparatus 12 arranged on the sheet conveyance path P1, the second image forming apparatus 15 arranged on the conveyance path P1 at a position farther downstream than the first image forming apparatus 12 in the sheet conveyance direction, the first inspection device 13 arranged on the conveyance path P1 between the first image forming apparatus 12 and the second image forming apparatus 15 and reads a sheet conveyed through the conveyance path P1, and the second inspection device 16 arranged on the conveyance path P1 at a position farther downstream than the second image forming apparatus 15 in the conveyance direction and reads a sheet conveyed through the conveyance path P1. Because the first inspection device 13 is arranged on the conveyance path P1 between the first image forming apparatus 12 and the second image forming apparatus 15, it is possible to inspect whether an abnormality has occurred in the first image forming apparatus 12. Further, because the second inspection device 16 is arranged on the conveyance path P1 at a position farther downstream than the second image forming apparatus 15, it is possible to detect an abnormality of the first image forming apparatus 12 and the second image forming apparatus 15. It is possible to determine which of the first image forming apparatus 12 and the second image forming apparatus 15 is abnormal based on an inspection result of the first inspection device 13, an inspection result of the second inspection device 16, and an operation of each of the first image forming apparatus 12 and the second image forming apparatus 15.

Further, the CPU 111 included in the image forming system 1 causes the first image forming apparatus 12 to form an image on the first side of a sheet and not to form an image on the second side opposite to the first side, and detects an abnormality of the first image forming apparatus 12 based on image data output by the first inspection device 13 that reads the sheet, and the first inspection device 13 reads the first side and the second side of the sheet. Therefore, it is possible to detect an abnormality occurring on each of the first side on which an image is formed by the first image forming apparatus 12 and the second side on which an image is not formed by the first image forming apparatus 12.

Further, the CPU 111 included in the image forming system 1 detects an abnormality of the first image forming apparatus 12 based on image data output by the first inspection device 13 that reads the first side. Therefore, it is possible to detect an abnormality related to formation of an image by the first image forming apparatus 12.

Further, the CPU 111 included in the image forming system 1 detects an abnormality of the first image forming apparatus 12 based on image data output by the first inspection device 13 that reads the second side. Therefore, it is possible to detect an abnormality related to conveyance of a sheet during image formation by the first image forming apparatus 12.

Further, the CPU 111 included in the image forming system 1 prohibits image formation by the second image forming apparatus 15 on a sheet on which an image has been formed by the first image forming apparatus 12 having an abnormality that has been detected by the first inspection device 13. Therefore, it is possible to save energy by not causing the second image forming apparatus 15 to perform an unnecessary operation.

Further, the CPU 111 included in the image forming system 1 causes the second image forming apparatus 15 to form an image on the second side of a sheet and not to form an image on the first side, and detects an abnormality of the second image forming apparatus 15 based on image data output by the second inspection device 16 that reads the sheet, and the second inspection device 16 reads the first side and the second side of the sheet. Therefore, it is possible to detect an abnormality occurring in each of the second side on which an image is formed by the second image forming apparatus 15 and the first side on which an image is not formed by the second image forming apparatus 15.

Further, the CPU 111 included in the image forming system 1 changes the criterion for detection of an abnormality of the second image forming apparatus 15 based on image data output by the first inspection device 13 that reads a sheet. An image is formed by the first image forming apparatus 12 on the first side of a sheet to be read by the second inspection device 16. Therefore, part of an image formed on the first side may be included in the image data output by the second inspection device 16 that reads the sheet. Because the criterion for detection of an abnormality of the second image forming apparatus 15 is changed based on image data output by the first inspection device 13 that reads a sheet, an abnormality of the second image forming apparatus 15 can be accurately detected.

Further, the CPU 111 included in the image forming system 1 detects an abnormality of the second image forming apparatus 15 based on image data output by the second inspection device 16 that reads the second side of a sheet. Therefore, it is possible to detect an abnormality related to image formation by the second image forming apparatus 15.

The CPU 111 included in the image forming system 1 detects an abnormality of the second image forming apparatus 15 based on image data output by the second inspection device 16 that reads the first side of a sheet. Therefore, it is possible to detect an abnormality related to conveyance of a sheet during image formation by the second image forming apparatus 15.

In a case in which an abnormality is detected in one of the first image forming apparatus 12 and the second image forming apparatus 15 and no abnormality is detected in the other one of the first image forming apparatus 12 and the second image forming apparatus 15, the CPU 111 included in the image forming system 1 prohibits image formation by one of the first image forming apparatus 12 and the second image forming apparatus 15 in which an abnormality has been detected, and causes the other one of the first image forming apparatus 12 and the second image forming apparatus 15 to form images on both sides of a sheet. Therefore, even in a case in which images cannot be formed on both sides of a sheet using both of the first image forming apparatus 12 and the second image forming apparatus 15, images can be formed on both sides of the sheet.

Further, in a case in which the second inspection device 16 forms images on both sides of a sheet, the CPU 111 included in the image forming system 1 detects an abnormality of the sheet passing through the first image forming apparatus 12 based on image data output by the first inspection device 13 that reads the sheet. In a case in which an abnormality of a sheet is detected, the CPU 111 included in the image forming system 1 prohibits image formation by the second image forming apparatus 15. Therefore, it is possible to detect an abnormality related to the conveyance of a sheet by the first image forming apparatus 12, and it is possible to prevent generation of a sheet having an image defect.

### <Overview of Embodiments>

(Item 1) An image forming system may comprise a first image forming apparatus arranged on a conveyance path of a recording medium, a second image forming apparatus arranged on the conveyance path at a position farther downstream than the first image forming apparatus in a conveyance direction of the recording medium, a first reading section arranged on the conveyance path between the first image forming apparatus and the second image forming apparatus, and reads the recording medium conveyed through the conveyance path, and a second reading section arranged on the conveyance path at a position farther downstream than the second image forming apparatus in the conveyance direction, and reads the recording medium conveyed through the conveyance path.

According to this aspect, because the first reading section is arranged on the conveyance path between the first image forming apparatus and the second image forming apparatus, it is possible to inspect whether an abnormality has occurred in the first image forming apparatus. Further, because the second reading section is arranged on the conveyance path at a position farther downstream than the second image forming apparatus, it is possible to detect an abnormality of the first image forming apparatus and the second image forming apparatus. It is possible to determine which one of the first image forming apparatus and the second image forming apparatus is abnormal based on an inspection result of the first reading section, an inspection result of the second reading section, and the respective operations of the first image forming apparatus and the second image forming apparatus. As a result, it is possible to provide an image forming system capable of inspecting the respective states of a plurality of respective image forming apparatuses.

(Item 2) The image forming system according to item 1 may further comprise a hardware processor, and the hardware processor causes the first image forming apparatus to form an image on a first side of a recording medium and not to form an image on a second side opposite to the first side, and detects an abnormality of the first image forming apparatus based on image data output by the first reading section that reads the recording medium, wherein the first reading section reads the first side and the second side of the recording medium.

According to this aspect, an image is formed on the first side of the recording medium by the first image forming apparatus, and an abnormality of the first image forming apparatus is detected based on the image data output by the first reading section that reads the recording medium. Therefore, it is possible to detect an abnormality occurring on each of the first side on which an image is formed by the first image forming apparatus and the second side on which an image is not formed by the first image forming apparatus.

(Item 3) The image forming system according to item 2, wherein the hardware processor detects an abnormality of the first image forming apparatus based on image data output by the first reading section that reads the first side.

According to this aspect, it is possible to detect an abnormality related to image formation by the first image forming apparatus.

(Item 4) The image forming system according to item 2 or 3, wherein the hardware processor detects an abnormality of the first image forming apparatus based on image data output by the first reading section that reads the second side.

According to this aspect, it is possible to detect an abnormality related to conveyance of a recording medium during image formation by the first image forming apparatus.

(Item 5) The image forming system according to any one of items 2 to 4, wherein the hardware processor prohibits image formation by the second image forming apparatus on a recording medium on which an image that has been formed by the first image forming apparatus from which an abnormality has been detected.

According to this aspect, an image is not formed by the second image forming apparatus on a recording medium on which an image has been formed by the first image forming apparatus having an abnormality that has been detected by the first inspector. Therefore, it is possible to save energy by not causing the second image forming apparatus to perform an unnecessary operation.

(Item 6) The image forming system according to any one of items 2 to 5, wherein the hardware processor causes the second image forming apparatus to form an image on the second side of a recording medium and not to form an image on the first side, detects an abnormality of the second image forming apparatus based on image data output by the second reading section that reads the recording medium, and the second reading section reads the first side and the second side of the recording medium.

According to this aspect, an image is formed on the second side of the recording medium by the second image forming apparatus, and an abnormality of the second image forming apparatus is detected based on image data output by the second reading portion that reads the recording medium. Therefore, it is possible to detect an abnormality occurring on each of the second side on which an image is formed by the second image forming apparatus and the first side on which an image is not formed by the second image forming apparatus.

(Item 7) The image forming system according to item 6, wherein the hardware processor changes a criterion for detection of an abnormality of the second image forming apparatus based on image data output by the first reading section that reads a recording medium.

According to this aspect, the criterion for detection of an abnormality of the second image forming apparatus is changed based on the image data output by the first reading portion that reads the recording medium. An image is formed by the first image forming apparatus on a first side of the recording medium to be read by the second reading section. Therefore, part of the image formed on the first side may be included in the image data output by the second reading section that reads the recording medium. Because the criterion for detection of an abnormality of the second image forming apparatus is changed based on the image data output by the first reading section that reads the recording medium, it is possible to accurately detect an abnormality of the second image forming apparatus.

(Item 8) The image forming system according to item 6 or 7, wherein the hardware processor detects an abnormality of the second image forming apparatus based on image data output by the second reading section that reads the second side of a recording medium.

According to this aspect, it is possible to detect an abnormality related to image formation by the second image forming apparatus.

(Item 9) The image forming system according to item 8, wherein the hardware processor detects an abnormality of the second image forming apparatus based on image data output by the second reading section that reads the first side of a recording medium.

According to this aspect, it is possible to detect an abnormality related to conveyance of the recording medium during image formation by the second image forming apparatus.

(Item 10) The image forming system according to any one of items 6 to 9, wherein in a case in which an abnormality is detected in either one of the first image forming apparatus and the second image forming apparatus and an abnormality is not detected in another one of the first image forming apparatus and the second image forming apparatus, the hardware processor prohibits image formation by the one of the first image forming apparatus and the second image forming apparatus from which an abnormality has been detected and causes the another one of the first image forming apparatus and the second image forming apparatus to form images on both sides of a recording medium.

According to this aspect, image formation by one of the first image forming apparatus and the second image forming apparatus in which an abnormality has been detected is prohibited, and images are formed on both sides of the recording medium by the other one of the first image forming apparatus and the second image forming apparatus. Therefore, even in a case in which images cannot be formed on both sides of the recording medium using both of the first image forming apparatus and the second image forming apparatus, images can be formed on both sides of the recording medium.

(Item 11) The image forming system according to item 10, wherein the hardware processor, in a case in which the second image forming apparatus forms images on both sides of a recording medium, detects an abnormality of the recording medium passing through the first image forming apparatus based on image data output by the first reading section that reads the recording medium, and in a case in which an abnormality of a recording medium is detected by the first inspector, prohibits image formation by the second image forming apparatus.

According to this aspect, in a case in which the second image forming apparatus forms images on both sides of the recording medium, an abnormality of the recording medium passing through the first image forming apparatus is detected based on the image data output by the first reading portion that reads the recording medium. In a case in which an abnormality of the recording medium is detected, image formation by the second image forming apparatus is prohibited. Therefore, it is possible to detect an abnormality related to conveyance of the recording medium by the first image forming apparatus, and it is possible to prevent generation of a sheet having an image defect.

(Item 12) An image forming method that is performed in an image forming system, wherein the image forming system may comprise a first image forming apparatus arranged on a conveyance path of a recording medium, a second image forming apparatus arranged on the conveyance path at a position farther downstream than the first image forming apparatus in a conveyance direction of the recording medium, a first reading section arranged on the conveyance path between the first image forming apparatus and the second image forming apparatus, and reads the recording medium conveyed through the conveyance path, and a second reading section arranged on the conveyance path at a position farther downstream than the second image forming apparatus in the conveyance direction, and reads the recording medium conveyed through the conveyance path, and the image forming method may comprise a device control step of causing the first image forming apparatus to form an image on a first side of the recording medium and not to form an image on a second side opposite to the first side, and causing the second image forming apparatus to form an image on the second side of the recording medium and not to form an image on the first side, a first inspection step of detecting an abnormality of the first image forming apparatus based on image data output by the first reading section that reads the first side and the second side of the recording medium, and a second inspection step of detecting an abnormality of the second image forming apparatus based on image data output by the second reading section that reads the first side and the second side of the recording medium.

According to this aspect, it is possible to provide the image forming method with which it is possible to inspect the respective states of a plurality of respective image forming apparatuses.

(Item 13) A non-transitory computer-readable recording medium is encoded with an image forming program executed by a computer that controls an image forming system, wherein the image forming system may comprise a first image forming apparatus arranged on a conveyance path of a recording medium, a second image forming apparatus arranged on the conveyance path at a position farther downstream than the first image forming apparatus in a conveyance direction of the recording medium, a first reading section arranged on the conveyance path between the first image forming apparatus and the second image forming apparatus, and reads the recording medium conveyed through the conveyance path, and a second reading section arranged on the conveyance path at a position farther downstream than the second image forming apparatus in the conveyance direction, and reads the recording medium conveyed through the conveyance path, and the image forming program causes a computer to perform a device control step of causing the first image forming apparatus to form an image on a first side of the recording medium and not to form an image on a second side opposite to the first side, and causing the second image forming apparatus to form an image on the second side of the recording medium and not to form an image on the first side, a first inspection step of detecting an abnormality of the first image forming apparatus based on image data output by the first reading section that reads the first side and the second side of the recording medium, and a second inspection step of detecting an abnormality of the second image forming apparatus based on image data output by the second reading section that reads the first side and the second side of the recording medium.

According to this aspect, it is possible to provide the image forming program that enables inspection of respective states of a plurality of respective image forming apparatuses.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming system comprising:
a first image forming apparatus arranged on a conveyance path of a recording medium;
a second image forming apparatus arranged on the conveyance path at a position farther downstream than the first image forming apparatus in a conveyance direction of the recording medium;
a first reading section arranged on the conveyance path between the first image forming apparatus and the second image forming apparatus, and reads the recording medium conveyed through the conveyance path; and
a second reading section arranged on the conveyance path at a position farther downstream than the second image forming apparatus in the conveyance direction, and reads the recording medium conveyed through the conveyance path.

2. The image forming system according to claim 1, further comprising a hardware processor,
the hardware processor
causing the first image forming apparatus to form an image on a first side of a recording medium and not to form an image on a second side opposite to the first side; and
detecting an abnormality of the first image forming apparatus based on image data output by the first reading section that reads the recording medium, wherein
the first reading section reads the first side and the second side of the recording medium.

3. The image forming system according to claim 2, wherein
the hardware processor detects an abnormality of the first image forming apparatus based on image data output by the first reading section that reads the first side.

4. The image forming system according to claim 3, wherein
the hardware processor detects an abnormality of the first image forming apparatus based on image data output by the first reading section that reads the second side.

5. The image forming system according to claim 2, wherein
the hardware processor prohibits image formation by the second image forming apparatus on a recording medium on which an image has been formed by the first image forming apparatus from which an abnormality has been detected.

6. The image forming system according to claim 2, wherein
the hardware processor
causes the second image forming apparatus to form an image on the second side of a recording medium and not to form an image on the first side,
detects an abnormality of the second image forming apparatus based on image data output by the second reading section that reads the recording medium, and
the second reading section reads the first side and the second side of the recording medium.

7. The image forming system according to claim 6, wherein
the hardware processor changes a criterion for detection of an abnormality of the second image forming apparatus based on image data output by the first reading section that reads a recording medium.

8. The image forming system according to claim 6, wherein
the hardware processor detects an abnormality of the second image forming apparatus based on image data output by the second reading section that reads the second side of a recording medium.

9. The image forming system according to claim 8, wherein
the hardware processor detects an abnormality of the second image forming apparatus based on image data output by the second reading section that reads the first side of a recording medium.

10. The image forming system according to claim 6, wherein
in a case in which an abnormality is detected in either one of the first image forming apparatus and the second image forming apparatus and an abnormality is not detected in another one of the first image forming apparatus and the second image forming apparatus, the hardware processor prohibits image formation by the one of the first image forming apparatus and the second image forming apparatus from which an abnormality has been detected and causes the another one of the first image forming apparatus and the second image forming apparatus to form images on both sides of a recording medium.

11. The image forming system according to claim 10, wherein
the hardware processor,
in a case in which the second image forming apparatus forms images on both sides of a recording medium, detects an abnormality of the recording medium passing through the first image forming apparatus based on image data output by the first reading section that reads the recording medium, and
in a case in which an abnormality of a recording medium is detected by the first inspector, prohibits image formation by the second image forming apparatus.

12. An image forming method that is performed in an image forming system,
the image forming system comprising:
first image forming apparatus arranged on a conveyance path of a recording medium;
a second image forming apparatus arranged on the conveyance path at a position farther downstream than the first image forming apparatus in a conveyance direction of the recording medium;
a first reading section arranged on the conveyance path between the first image forming apparatus and the second image forming apparatus, and reads the recording medium conveyed through the conveyance path; and
a second reading section arranged on the conveyance path at a position farther downstream than the second image forming apparatus in the conveyance direction, and reads the recording medium conveyed through the conveyance path, and
the image forming method including:
a device control step of causing the first image forming apparatus to form an image on a first side of the recording medium and not to form an image on a second side opposite to the first side, and causing the second image forming apparatus to form an image on the second side of the recording medium and not to form an image on the first side;
a first inspection step of detecting an abnormality of the first image forming apparatus based on image data output by the first reading section that reads the first side and the second side of the recording medium; and
a second inspection step of detecting an abnormality of the second image forming apparatus based on image data output by the second reading section that reads the first side and the second side of the recording medium.

13. A non-transitory computer-readable recording medium encoded with an image forming program executed by a computer that controls an image forming system,
the image forming system comprising:
a first image forming apparatus arranged on a conveyance path of a recording medium;
a second image forming apparatus arranged on the conveyance path at a position farther downstream than the first image forming apparatus in a conveyance direction of the recording medium;
a first reading section arranged on the conveyance path between the first image forming apparatus and the second image forming apparatus, and reads the recording medium conveyed through the conveyance path; and
a second reading section arranged on the conveyance path at a position farther downstream than the second image forming apparatus in the conveyance direction, and reads the recording medium conveyed through the conveyance path, and
the image forming program causing a computer to perform:
a device control step of causing the first image forming apparatus to form an image on a first side of the recording medium and not to form an image on a second side opposite to the first side, and causing the second image forming apparatus to form an image on the second side of the recording medium and not to form an image on the first side;
a first inspection step of detecting an abnormality of the first image forming apparatus based on image data output by the first reading section that reads the first side and the second side of the recording medium; and
a second inspection step of detecting an abnormality of the second image forming apparatus based on image data output by the second reading section that reads the first side and the second side of the recording medium.
